(19) United States
(12) Patent Application Publication
(10) Pub. No.: US 2023/0342005 A1
(43) Pub. Date: Oct. 26, 2023

(54) STORAGE MEDIUM, INFORMATION PROCESSOR, SERVICE PROVISION SYSTEM AND CONTROL METHOD OF SERVICE PROVISION SYSTEM

(71) Applicant: Panasonic Intellectual Property Management Co., Ltd., Osaka (JP)

(72) Inventors: Hiroyoshi OHMIYA, Osaka (JP); Takuro ITO, Osaka (JP)

(21) Appl. No.: 18/300,818

(22) Filed: Apr. 14, 2023

(30) Foreign Application Priority Data
Apr. 20, 2022 (JP) 2022-069197

(51) Int. Cl. G06F 3/0482; G06Q 30/0226

(52) U.S. Cl. CPC G06F 3/0482; G06Q 30/0226

(57) ABSTRACT

A non-transitory computer-readable storage medium storing a program causes a processor of an information processor used by a user of a subscription service including provision of articles associated with life to function as a display control unit configured to display a selection screen where the plurality of articles to be provided are selectable based on values of the articles.

### INCORPORATION BY REFERENCE

The present application claims priority under 35 U.S.C. § 119 to Japanese Patent Application No. 2022-069197 filed on Apr. 20, 2022. The content of the application(s) is incorporated herein by reference in its entirety.

### BACKGROUND OF THE INVENTION

### Field of the Invention

The present disclosure relates to a storage medium, an information processor, a service provision system and a control method of the service provision system.

### Description of the Related Art

Japanese Patent No. 7033725 discloses a subscription service that provides combinations of leases or rentals of home electric appliances and periodic provision of commodities associated with the home electric appliances.

The present disclosure provides a storage medium, an information processor, a service provision system and a control method of the service provision system capable of improving convenience of a user of a subscription service.

### SUMMARY OF THE INVENTION

A non-transitory computer-readable storage medium storing a program in the present disclosure causes a processor of an information processor used by a user of a subscription service including provision of articles associated with life to function as a display control unit configured to display a selection screen where the plurality of articles to be provided are selectable based on values of the articles.

In addition, an information processor in the present disclosure is the information processor used by a user of a subscription service including provision of articles associated with life, and includes a display control unit configured to display a selection screen where the plurality of articles to be provided are selectable based on values of the articles.

Further, a service provision system in the present disclosure is the service provision system which provides a subscription service including provision of articles associated with life, and includes an information processor used by a user of the subscription service and a server device configured to communicate with the information processor, the information processor displays a selection screen where the plurality of articles to be provided are selectable based on values of the articles, and the server device provides the articles selected on the selection screen to the user.

Still further, a control method of a service provision system in the present disclosure is the control method of the service provision system which provides a subscription service including provision of articles associated with life, and includes: a step of displaying a selection screen where the plurality of articles to be provided are selectable based on values of the articles by an information processor used by a user of the subscription service; and a step of providing the articles selected on the selection screen to the user.

The storage medium, the information processor, the service provision system and the control method of the service provision system in the present disclosure enable a user of a subscription service to be provided with articles associated with life in a desired combination. Thus, convenience of the user of the subscription service can be improved.

### BRIEF DESCRIPTION OF THE DRAWINGS

FIG. 1 is a diagram illustrating a configuration of a service provision system in an embodiment 1;

FIG. 2 is a block diagram illustrating configurations of an information processor and a server device in the embodiment 1;

FIG. 3 shows flowcharts illustrating operations of the information processor and the server device in the embodiment 1;

FIG. 4 shows flowcharts illustrating the operations of the information processor and the server device in the embodiment 1;

FIG. 5 is a diagram illustrating an example of a first selection screen in the embodiment 1;

FIG. 6 is a diagram illustrating an example of the first selection screen in the embodiment 1;

FIG. 7 shows flowcharts illustrating the operations of the information processor and the server device in the embodiment 1; and

FIG. 8 is a diagram illustrating an example of a second selection screen in the embodiment 1.

### DETAILED DESCRIPTION OF THE PREFERRED EMBODIMENTS

### Underlying Knowledge or the Like of Present Disclosure

When inventors conceived the present disclosure, there was a subscription service that provides combinations of leases or rentals of home electric appliances and periodic provision of commodities associated with the home electric appliances. However, in the conventional subscription service, a commodity that can be provided is determined for one home electric appliance. The inventors found the problem that, in the conventional subscription service, a user of the subscription service could not be provided with articles associated with life in a desired combination and there was room for improvement in convenience, and came to configure a subject of the present disclosure in order to solve the problem.

Therefore, the present disclosure provides a storage medium, an information processor, a service provision system and a control method of the service provision system capable of improving convenience of a user of a subscription service.

Hereinafter, the embodiments will be explained in detail with reference to the drawings. However, explanations detailed more than necessary may be omitted. For example, the detailed explanations of already well-known matters or redundant explanations for practically identical configurations may be omitted.

Note that the attached drawings and the explanation below are provided for persons skilled in the art to fully understand the present disclosure, and it is not intended to limit the subject described in the scope of claims by them.

### Embodiment 1

### 1-1. Configuration

### 1-1-1. Configuration of Service Provision System

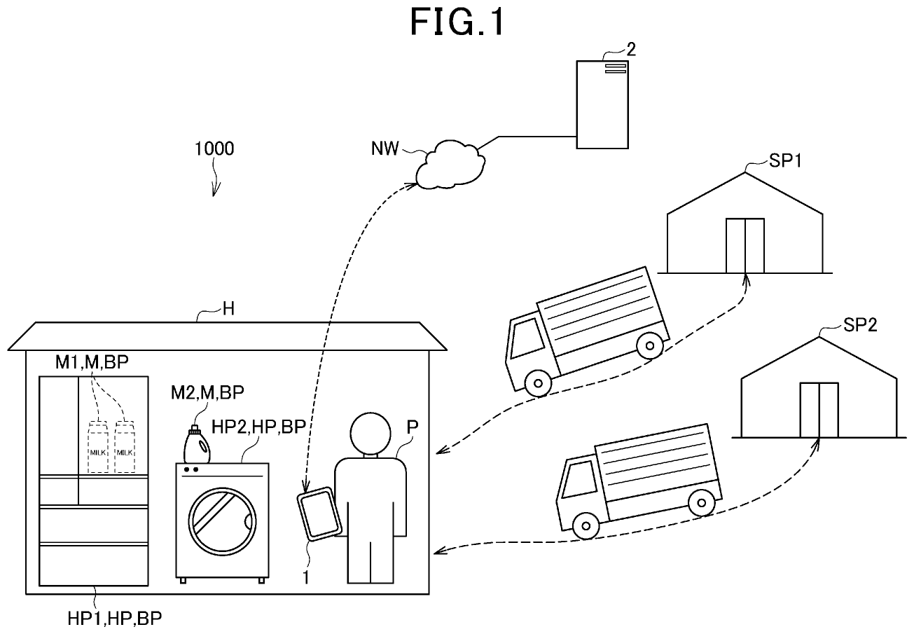

FIG. 1 is a diagram illustrating the configuration of a service provision system 1000.

The service provision system 1000 is a system which provides a subscription service. The subscription service is a subscription type service usable for a fixed period of time by paying a utilization charge.

The subscription service of the present embodiment is a service that article BP associated with life can be utilized for one month by paying a monthly utilization charge. In the subscription service of the present embodiment, when a user P pays the utilization charge every month, a utilizable period of the article BP is extended for one month. Here, the article BP associated with life is the article BP associated with the life in a facility H. While a house of the user P is exemplified as the facility H in FIG. 1, the facility H is not limited to the house and may be a place where the user P lives. The articles BP associated with the life in the present embodiment include home electric appliances HP and commodities M associated with the home electric appliances HP. The commodities M include consumables in the home electric appliances HP and consumables in the life such as food or the like.

In the subscription service of the present embodiment, the user P is provided with the articles BP from the service provision system 1000. The user P is provided with the home electric appliances HP in a mode of leases or rentals. In addition, the user P is provided with the commodities M by purchase of the commodities M. The home electric appliances HP provided in the subscription service may be the home electric appliances HP of a same maker or may be the home electric appliances HP of different makers. The commodities M provided in the subscription service may be the commodities M sold by one retailer or may be the commodities M sold by a plurality of retailers.

The service provision system 1000 includes an information processor 1 used by the user P of the subscription service. The information processor 1 illustrated in FIG. 1 is a portable computer such as a smartphone. Note that the information processor 1 is not limited to a tablet-type computer such as a smartphone, and may be a desktop-type computer or a laptop-type computer. To the information processor 1, an application program for utilizing the subscription service is installed, and communication is performed with a server device 2 by a function of the application program. The information processor 1 communicate with the server device 2 through a router provided in a facility H, or without the router provided in the facility H. Hereinafter, the application program is referred to as a “service utilization application” and a sign “111” is attached.

The service utilization application 111 corresponds to a “program” of the present disclosure.

The service provision system 1000 includes the server device 2. The server device 2 is connected to a network NW configured by a public network, an exclusive line and other communication circuits or the like. The server device 2 is a device which performs processing relating to the subscription service with the information processor 1 connected to the network NW as a client. Note that, while the server device 2 is expressed by one block in each diagram, this does not necessarily mean that the server device 2 is configured by a single device.

The user P operates the information processor 1 and selects the articles BP to be provided in the subscription service. When the articles BP are to be selected, the information processor 1 displays a selection screen SG. The selection screen SG is a screen for selecting the articles BP to be provided. The selection screen SG includes a first selection screen SG1 and a second selection screen SG2 to be described later. When the articles BP are selected on the selection screen SG, the server device 2 requests delivery of the selected articles BP to a delivery agent.

The server device 2 of the present embodiment requests the delivery of the home electric appliances HP selected on the selection screen SG to a first delivery agent SP1. For example, the server device 2 transmits email of a delivery request to the first delivery agent SP1. When the delivery request is received from the server device 2, the first delivery agent SP1 delivers the home electric appliances HP selected by the user P to the user P.

The server device 2 of the present embodiment requests the delivery of the commodities M selected on the selection screen SG to a second delivery agent SP2. For example, the server device 2 transmits the email of the delivery request to the second delivery agent SP2. When the delivery request is received from the server device 2, the second delivery agent SP2 delivers the commodities M selected by the user P to the user P.

FIG. 1 illustrates a case where the user P selects a refrigerator HP1, a washing machine HP2, milk M1 and a detergent M2 on the selection screen SG and the user P is provided with the refrigerator HP1, the washing machine HP2, the milk M1 and the detergent M2. The refrigerator HP1 and the washing machine HP2 are delivered by the first delivery agent SP1, and the milk M1 and the detergent M2 are delivered by the second delivery agent SP2.

Note that, while the delivery agent who delivers the home electric appliances HP and the delivery agent who delivers the commodities M are different delivery agents in the present embodiment, the delivery agent who delivers the home electric appliances HP and the delivery agent who delivers the commodities M may be the same delivery agent. In addition, at least one of the delivery agent who delivers the home electric appliances HP and the delivery agent who delivers the commodities M may be a subject which manages or uses the server device 2. Further, the delivery agent who delivers the home electric appliances HP may be different delivery agents according to the makers of the home electric appliances HP and kinds of the home electric appliances HP. Furthermore, the delivery agent who delivers the commodities M may be different delivery agents according to the kinds of the commodities M.

### 1-1-2. Configuration of Server Device

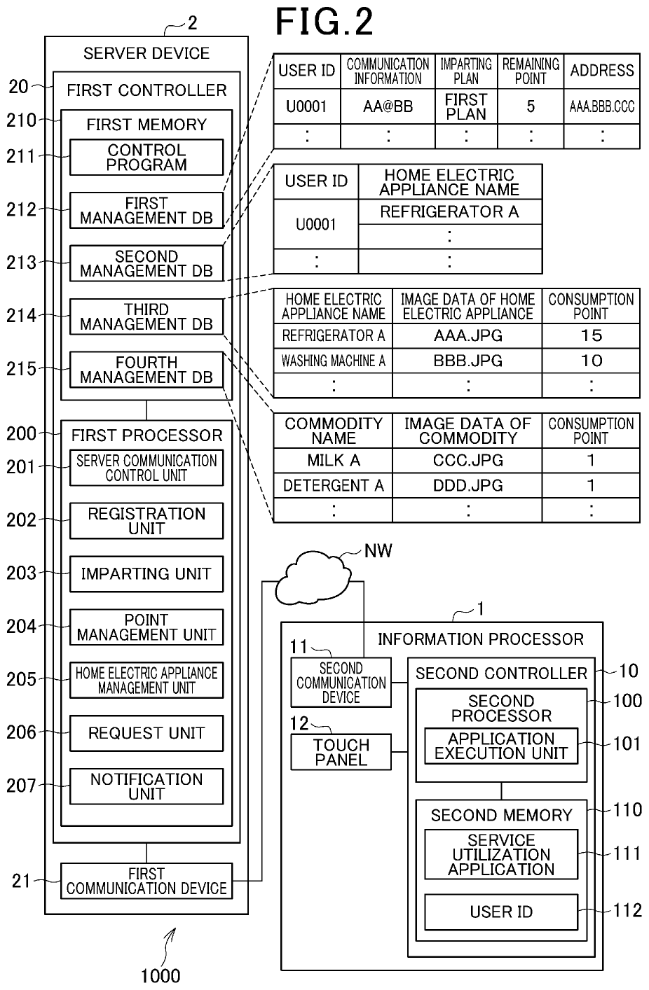

FIG. 2 is a block diagram illustrating the configurations of the information processor 1 and the server device 2.

The configuration of the server device 2 will be explained first.

The server device 2 includes a first controller 20 and a first communication device 21.

The first controller 20 includes a first processor 200 which is a processor such as a CPU (Central Processing Unit) or an MPU (Micro-Processing Unit), a first memory 210 (storage medium), and an interface circuit to which other devices and sensors are connected.

The first memory 210 is a storage device which stores a program to be executed by the first processor 200 and data in a nonvolatile manner. The first memory 210 is configured by a magnetic storage device, a semiconductor storage element such as a flash ROM (Read Only Memory), or a nonvolatile storage device of other kinds. In addition, the first memory 210 may include a RAM (Random Access Memory) configuring a work area of the first processor 200. Further, the first memory 210 may include a nonvolatile storage device such as an HDD (Hard Disk Drive) and an SSD (Solid State Drive). The first memory 210 stores the data to be processed by the first processor 200, a control program 211 to be executed by the first processor 200, a first management DB (Data Base) 212, a second management DB 213, a third management DB 214, and a fourth management DB 215.

The first management DB 212 is a data base which manages the data related to the user P of the subscription service. One record stored in the first management DB 212 includes a user ID (Identification) 112, communication information, selected plan information, remaining point information indicating remaining points NP and address information.

The user ID 112 is identification information which uniquely specifies the user P.

The communication information is the information for communicating with the information processor 1, and is predetermined address information for example.

The selected plan information is the information indicating a selected plan. The selected plan is an imparting plan selected by the user P. The imparting plan is a plan in which points to be imparted according to a monthly utilization charge are stipulated. Here, the points are the numbers of points. In the subscription service of the present embodiment, the plurality of imparting plans in which the points to be imparted according to the monthly utilization charge are different are set. For example, in the subscription service, three imparting plans that are a first plan to impart 30 points by the monthly utilization charge of 30,000 yen, a second plan to impart 20 pints by the monthly utilization charge of 20,000 yen and a third plan to impart 10 points by the monthly utilization charge of 10,000 yen are set.

The remaining points NP indicate the remainder of the imparted points which are the points imparted to the user P. The remaining points NP are used to select the articles BP on the selection screen SG.

That is, the points are utilized to be exchanged for the articles BP.

The address information is the information indicating an address of the facility H.

The second management DB 213 is a data base which manages the data related to the home electric appliances HP selected by the user P on the selection screen SG. One record stored in the second management DB 213 includes the user ID 112 and home electric appliance name information.

The home electric appliance name information is the information indicating a home electric appliance name which is a name of the home electric appliance HP.

The third management DB 214 is a data base which manages the data related to the home electric appliances HP. One record stored in the third management DB 214 includes the home electric appliance name information, image data of the home electric appliance HP, and the information of consumption points CP.

The consumption points CP are the points to be consumed when the articles BP are provided in the subscription service. To the articles BP, the consumption points CP for each article BP are set. The consumption points CP indicate a value of the article BP, and a higher numerical value is set when the value of the article BP is higher. In the present embodiment, the value of the article BP is determined by a price of the article BP. Thus, for the consumption points CP in the present embodiment, the higher numerical value is set when the price of the article BP is higher.

The fourth management DB 215 is a data base which manages the data related to the commodities M. One record stored in the fourth management DB 215 includes commodity name information, image data of the commodity M and the information of the consumption points CP.

The commodity name information is the information indicating a commodity name which is a name of the commodity M.

The first communication device 21 includes communication hardware such as a communication circuit according to a predetermined communication standard, and communicates with devices connected to the network NW, such as the information processor 1 and a mail server used by the delivery agent. A communication standard of the first communication device 21 may be a wireless communication standard or a cable communication standard.

The first processor 200 functions as a server communication control unit 201, a registration unit 202, an imparting unit 203, a point management unit 204, a home electric appliance management unit 205, a request unit 206 and a notification unit 207, by reading and executing the control program 211.

The server communication control unit 201 communicates with the information processor 1 through the first communication device 21.

The registration unit 202 registers for utilization of the subscription service. The registration unit 202 registers for the utilization of the subscription service by generating a record to be stored in the first management DB 212 and storing the generated record in the first management DB 212.

The imparting unit 203 imparts the points according to the utilization charge to the user P. When the user P pays the monthly utilization charge, the imparting unit 203 imparts the points corresponding to the paid utilization charge to the user P.

For example, when the user P pays the monthly utilization charge, the imparting unit 203 acquires the user ID 112 of the user P who has paid the utilization charge from an external server which manages payment of the utilization charge. Then, the imparting unit 203 specifies the record of the user ID 112 acquired from the external server from the first management DB 212. Next, the imparting unit 203 refers to the selected plan information in the specified record, and updates the remaining points NP indicated by the remaining point information that the specified record has to the points stipulated by the selected plan. That is, in the subscription service of the present embodiment, the remainder of the imparted points cannot be carried over to the next month.

The point management unit 204 manages the remaining points NP. The point management unit 204 manages the remaining points NP by appropriately updating the remaining point information in the record stored by the first management DB. In the case where the user P is provided with the home electric appliance HP, when the imparting unit 203 imparts the points, the point management unit 204 subtracts the consumption points CP of the home electric appliance HP provided to the user P from the imparted points.

The home electric appliance management unit 205 manages the home electric appliances HP selected by the user P. The home electric appliance management unit 205 manages the home electric appliances HP selected by the user P by appropriately updating the home electric appliance name information linked with the user ID 112 for each record stored in the second management DB 213.

The request unit 206 requests the delivery to the delivery agent. The request unit 206 requests the delivery to the first delivery agent SP1 for the delivery request of the home electric appliances HP, and requests the delivery to the second delivery agent SP2 for the delivery request of the commodities M. For example, the request unit 206 transmits the email indicating the delivery request to a mail server used by the first delivery agent SP1. In the email, the home electric appliance name information of the home electric appliance HP to be delivered and the address information of a delivery destination are described. In addition, for example, the request unit 206 transmits the email indicating the delivery request to a mail server used by the second delivery agent SP2. In the email, the commodity name information of the commodity M to be delivered and the address information of the delivery destination are described.

The request unit 206 requests collection of the home electric appliances HP to the first delivery agent SP1. For example, the request unit 206 transmits the email indicating a collection request to the mail server used by the first delivery agent SP1. In the email, the home electric appliance name information of the home electric appliance HP which is a collection target and the address information of a collection destination are described.

The notification unit 207 notifies the user P who has one or more remaining points NP predetermined days before a utilization end date (for example, the last day of the month) of the subscription service of that the remaining points NP are not 0. The notification unit 207 acquires the information of present date and time by a predetermined method, and when the acquired present date and time corresponds to the predetermined days before the utilization end date of the subscription service, refers to each record in the first management DB 212. Then, the notification unit 207 refers to the communication information of the record including the remaining point information indicating the remaining points NP which are not 0, and notifies that the remaining points NP are not 0. The notification unit 207 performs notification by a predetermined notification mode such as email and push notification.

### 1-1-3. Configuration of Information Processor

Next, the configuration of the information processor 1 will be explained.

The information processor 1 includes a second controller 10, a second communication device 11 and a touch panel 12.

The second controller 10 is a device which controls individual units of the information processor 1. The second controller 10 includes a second processor 100 which is a processor such as a CPU or an MPU, a second memory 110 (storage medium), and an interface circuit to which other devices and sensors are connected.

The second processor 100 corresponds to a “processor” of the present disclosure.

The second memory 110 is a storage device which stores a program to be executed by the second processor 100 and data in the nonvolatile manner. The second processor 100 is configured by a magnetic storage device, a semiconductor storage element such as a flash ROM, or a nonvolatile storage device of other kinds. In addition, the second memory 110 may include a RAM configuring a work area of the second processor 100. Further, the second memory 110 may include a nonvolatile storage device such as an HDD and an SSD. The second memory 110 stores the data to be processed by the second processor 100, the service utilization application 111 to be executed by the second processor 100, and the user ID 112.

To the second controller 10, the second communication device 11 and the touch panel 12 are connected.

The second communication device 11 includes communication hardware such as a communication circuit according to a predetermined communication standard, and communicates with the server device 2. While the communication standard of the second communication device 11 is exemplified by the wireless communication standard, it may be the cable communication standard.

The touch panel 12 includes a display panel, and a touch sensor overlapped with or provided integrally with the display panel.

The second processor 100 functions as an application execution unit 101 by reading and executing the service utilization application 111 stored in the second memory 110.

The application execution unit 101 corresponds to a “display control unit” of the present disclosure.

The application execution unit 101 communicates with the server device 2 through the second communication device 11.

The application execution unit 101 displays the selection screen SG on the touch panel 12.

The application execution unit 101 receives various kinds of input from the user P through the selection screen SG.

### 1-2. Operations

Next, the operations of the individual units of the service provision system 1000 will be explained.

### 1-2-1. Operations Relating to Utilization Registration of Subscription Service

First, the operations of the individual units of the service provision system 1000 relating to the utilization registration of the subscription service will be explained.

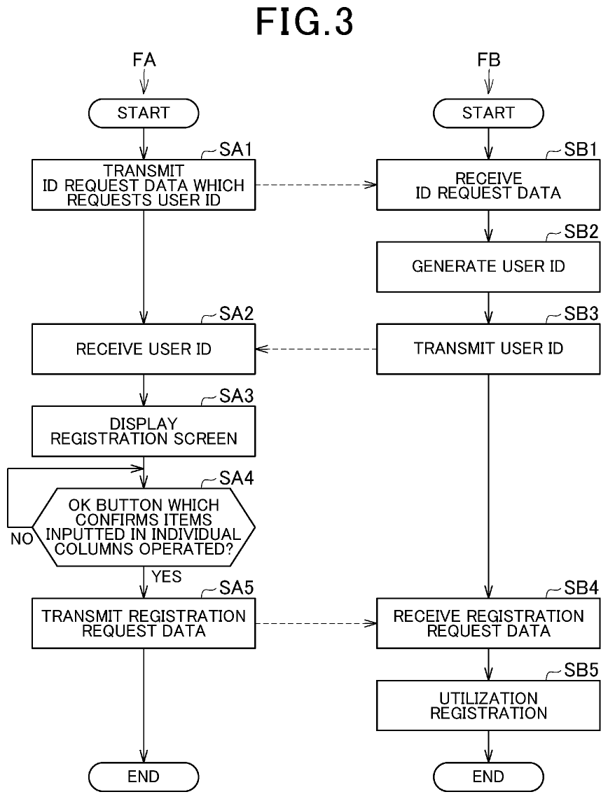

FIG. 3 shows flowcharts illustrating the operations of the information processor 1 and the server device 2.

In FIG. 3, a flowchart FA illustrates the operation of the information processor 1 and a flowchart FB illustrates the operation of the server device 2.

As illustrated in the flowchart FA, the application execution unit 101 transmits ID request data which requests the user ID 112 to the server device 2 (step SA1).

As illustrated in the flowchart FB, the server communication control unit 201 receives the ID request data (step SB1). Then, the server communication control unit 201 generates the user ID 112 (step SB2), and transmits the generated user ID 112 to the information processor 1 (step SB3).

As illustrated in the flowchart FA, the application execution unit 101 receives the user ID 112 from the server device 2 (step SA2). The user ID 112 received in step SA2 is stored in the second memory 110.

Next, the application execution unit 101 displays a registration screen (step SA3). The registration screen is a screen for inputting items to be registered in the utilization registration of the subscription service. The registration screen of the present embodiment includes an input column for inputting the imparting plan, an input column for inputting the address, and an OK button for confirming the items inputted in the individual input columns. Note that the kinds of the input columns provided on the registration screen are not limited to them and other input columns may be provided.

The application execution unit 101 determines whether or not the OK button for confirming the items inputted in the individual input columns is operated on the registration screen (step SA4).

When it is determined that the OK button for confirming the items inputted in the individual input columns is operated on the registration screen (step SA4: YES), the application execution unit 101 transmits registration request data to the server device 2 (step SA5). The registration request data is data which requests registration of the items inputted on the registration screen. In the registration request data, the imparting plan inputted on the registration screen, the address inputted on the registration screen, and the user ID 112 received in step SA2 are described.

As illustrated in the flowchart FB, the server communication control unit 201 receives the registration request data from the information processor 1 (step SB4).

Next, the registration unit 202 registers for the utilization of the subscription service based on the registration request data received in step SB4 (step SB5).

Step SB5 will be described in detail.

The registration unit 202 generates a record including the user ID 112 described in the registration request data, the selected plan information indicating the imparting plan described in the registration request data, the address information indicating the address described in the registration request data, the remaining point information indicating that the remaining point NP is 0, and the communication information. Then, the registration unit 202 stores the generated record in the first management DB 212.

After the utilization registration in step SB5, when the user P pays the utilization charge, the imparting unit 203 imparts the points.

### 1-2-2. Operations When Selecting Article on First Selection Screen

Next, the operations of the individual units of the service provision system 1000 after the utilization registration of the subscription service will be explained.

First, the operations when the user P selects the articles BP on the first selection screen SG1 will be explained. The first selection screen SG1 is the selection screen SG that the information processor 1 displays first after the utilization registration of the subscription service. That is, the first selection screen SG1 is the selection screen SG displayed when the user P selects the articles BP first after the utilization registration of the subscription service.

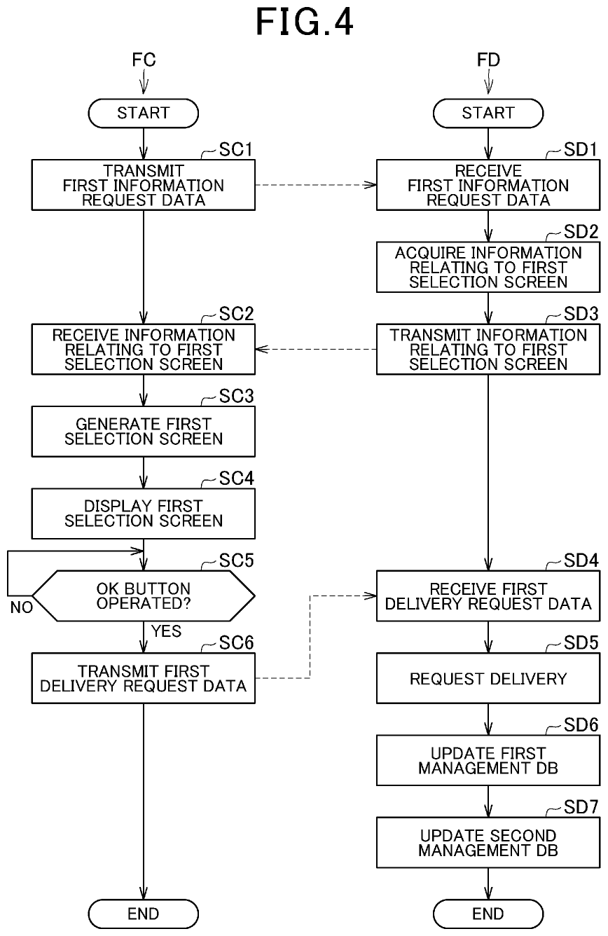

FIG. 4 shows flowcharts illustrating the operations of the information processor 1 and the server device 2.

In FIG. 4, a flowchart FC illustrates the operation of the information processor 1, and a flowchart FD illustrates the operation of the server device 2.

As illustrated in the flowchart FC, the application execution unit 101 transmits first information request data which requests the information relating to the first selection screen SG1 (step SC1). The first information request data includes the user ID 112 stored in the second memory 110.

As illustrated in the flowchart FD, the server communication control unit 201 receives the first information request data from the information processor 1 (step SD1).

The server communication control unit 201 acquires the information relating to the first selection screen SG1 based on the first information request data received in step SD1 (step SD2). In step SD2, the server communication control unit 201 acquires the remaining point information linked with the user ID 112 included in the first information request data from the first management DB 212, as the information relating to the first selection screen SG1. In addition, in step SD2, the server communication control unit 201 acquires all the records from the third management DB 214 and the fourth management DB 215, as the information relating to the first selection screen SG1.

The server communication control unit 201 transmits the information relating to the first selection screen SG1 which is acquired in step SD2 to the information processor 1 (step SD3).

As illustrated in the flowchart FC, the application execution unit 101 receives the information relating to the first selection screen SG1 from the server device 2 (step SC2).

Next, the application execution unit 101 generates the first selection screen SG1 based on the information relating to the first selection screen SG1 which is received in step SC2 (step SC3).

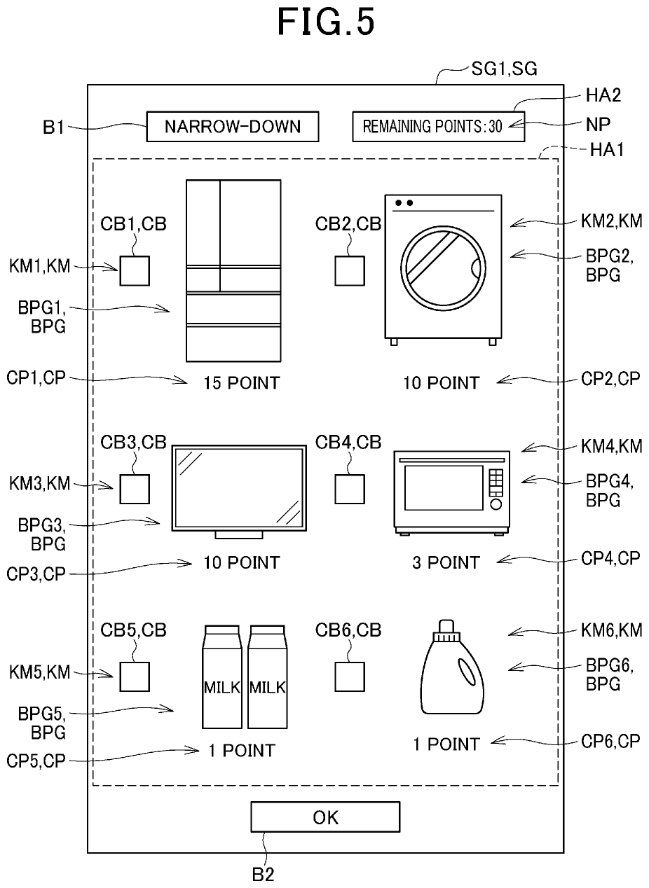

FIG. 5 is a diagram illustrating an example of the first selection screen SG1.

The first selection screen SG1 includes a first display area HA1.

The first display area HA1 is an area to display a combination KM of an article image BPG which is an image of the article BP, a checkbox CB and the consumption points CP, for each article BP. The first display area HA1 displays the combinations KM in two columns in an up-down direction in the figure. Note that a display mode of the two columns in the up-down direction is just an example and it may be two or more columns or one column. In the first display area HA1 illustrated in FIG. 5, the number of the combinations KM that can be displayed has an upper limit. Therefore, the combinations KM other than the combinations KM displayed in the first display area HA1 are not displayed on the first selection screen SG1. Note that, in the first display area HA1, a scroll operation is possible in the up-down direction in the figure. When the scroll operation is received in the first display area HA1, the application execution unit 101 displays the non-displayed combinations KM in the first display area HA1 corresponding to a scroll amount of the received scroll operation.

The first display area HA1 illustrated in FIG. 5 displays a combination KM1 of an article image BPG1 of the refrigerator HP1, a checkbox CB1 for selecting the refrigerator HP1 and consumption points CP1 of the refrigerator HP1. In addition, the first display area HA1 illustrated in FIG. 5 displays a combination KM2 of an article image BPG2 of the washing machine HP2, a checkbox CB2 for selecting the washing machine HP2 and consumption points CP2 of the washing machine HP2. Further, the first display area HA1 illustrated in FIG. 5 displays a combination KM3 of an article image BPG3 of a television, a checkbox CB3 for selecting the television and consumption points CP3 of the television. Furthermore, the first display area HA1 illustrated in FIG. 5 displays a combination KM4 of an article image BPG4 of a microwave oven, a checkbox CB4 for selecting the microwave oven and consumption points CP4 of the microwave oven. In addition, the first display area HA1 illustrated in FIG. 5 displays a combination KM5 of an article image BPG5 of milk, a checkbox CB5 for selecting the milk and consumption points CP5 of the milk. Further, the first display area HA1 illustrated in FIG. 5 displays a combination KM6 of an article image BPG6 of a detergent, a checkbox CB6 for selecting the detergent and consumption points CP6 of the detergent.

In generation of the first selection screen SG1, the application execution unit 101 generates the combination KM for each of the records stored in the third management DB 214 and the fourth management DB 215 which are received in step SC2, and displays the generated combinations KM side by side in the first display area HA1.

The first selection screen SG1 includes a second display area HA2. The second display area HA2 is an area to display the remaining points NP. In the second display area HA2 of the first selection screen SG1 generated in step SC3, the imparted points corresponding to the utilization charge paid by the user P are displayed as the remaining points NP.

In the generation of the first selection screen SG1, the application execution unit 101 displays the remaining points NP indicated by the remaining point information received in step SC2 in the second display area HA2.

Every time the checkbox CB displayed in the first display area HA1 is checked, the remaining points NP displayed in the second display area HA2 are updated to the points for which the consumption points CP corresponding to the checked checkbox CB are subtracted. Note that, on the selection screen SG, the selected article BP is the article BP for which the checkbox CB is checked.

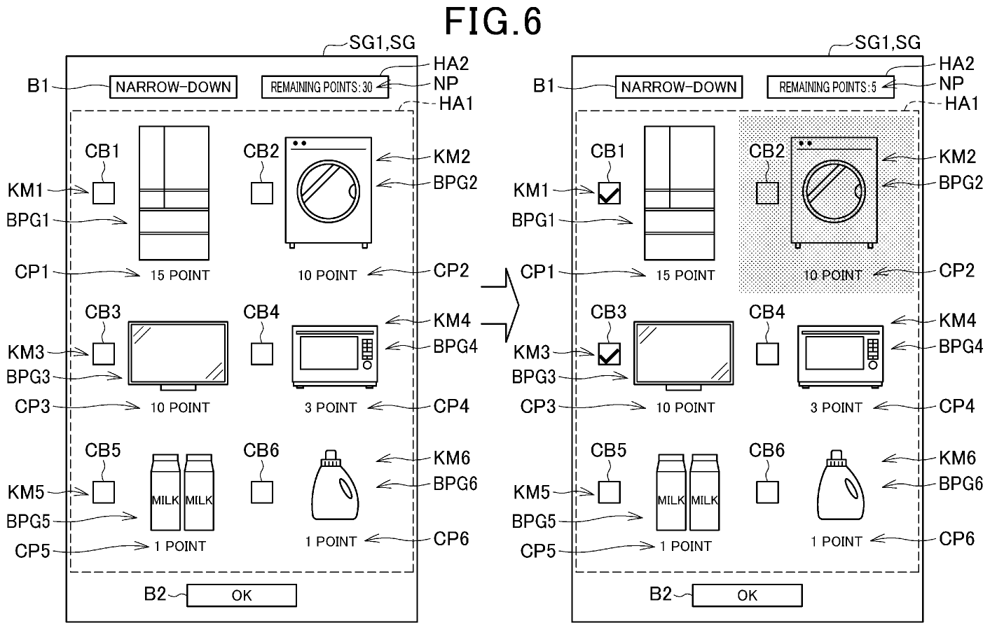

FIG. 6 is a diagram illustrating an example of the first selection screen SG1 when the checkbox CB is checked. FIG. 6 illustrates the case where each of the checkboxes CB1 and CB3 is checked.

As illustrated in FIG. 6, when the checkboxes CB1 and CB3 are checked, the application execution unit 101 updates the remaining points NP displayed in the second display area HA2 from 30 to 5 on the first selection screen SG1. Further, the application execution unit 101 grays out the combination KM for the article BP of the consumption points CP exceeding the updated remaining points NP on the selection screen SG, and displays the article BP in an unselectable manner. In FIG. 6, the application execution unit 101 displays the washing machine HP2 in the unselectable manner on the selection screen SG.

Returning to the explanation of the first selection screen SG1 with reference to FIG. 5, the first selection screen SG1 includes a narrow-down button B1. The narrow-down button B1 is a software button for narrowing down the kinds of the articles BP displayed in the first display area HA1. When the narrow-down button B1 is operated, the first selection screen SG1 lists and displays conditions for narrowing down the kinds of the articles BP displayed in the first display area HA1 in a selectable manner. For example, the first selection screen SG1 lists and displays various conditions such as the condition for performing narrowing-down by the kinds of the home electric appliances HP, the condition for performing the narrowing-down by the kinds of the commodities M and the condition for performing the narrowing-down by the consumption points. When the condition is selected, the application execution unit 101 displays only the articles BP satisfying the selected condition in the first display area HA1.

The first selection screen SG1 includes an OK button B2. The OK button B2 is a software button for confirming selection in the first display area HA1. The OK button B2 becomes operable when at least one checkbox CB is checked.

Returning to the explanation of the flowcharts in FIG. 4, the application execution unit 101 displays the first selection screen SG1 generated in step SC3 on the touch panel 12 (step SC4).

The application execution unit 101 determines whether or not the OK button B2 is operated on the first selection screen SG1 (step SC5).

When it is determined that the OK button B2 is operated (step SC5: YES), the application execution unit 101 transmits first delivery request data to the server device 2 (step SC6). The first delivery request data is data which requests the delivery of the article BP selected on the first selection screen SG1. The first delivery request data includes article name information of the article BP selected on the first selection screen SG1, the remaining point information indicating the remaining points NP when the OK button B2 is operated, and the user ID 112 stored in the second memory 110. Note that the article BP selected on the first selection screen SG1 indicates the article BP for which the checkbox CB is checked on the first selection screen SG1.

As illustrated in the flowchart FD, the server communication control unit 201 receives the first delivery request data from the information processor 1 (step SD4).

Next, the request unit 206 requests the delivery based on the first delivery request data received in step SD4 (step SD5). Since the article BP is provided by the delivery request, step SD5 corresponds to a step of providing the article BP to the user P.

Step SD5 will be explained in detail. The request unit 206 acquires the address information linked with the user ID 112 included in the first delivery request data from the first management DB 212. Then, when the first delivery request data includes the home electric appliance name information, the request unit 206 requests the delivery to the first delivery agent SP1 by notifying the first delivery agent SP1 of the home electric appliance name information included in the first delivery request data and the acquired address information. In addition, when the first delivery request data includes the commodity name information, the request unit 206 requests the delivery to the second delivery agent SP2 by notifying the second delivery agent SP2 of the commodity name information included in the first delivery request data and the acquired address information. Thus, the home electric appliances HP and the commodities M selected by the user P within the points can be provided.

Next, the point management unit 204 updates the first management DB 212 based on the first delivery request data received in step SD4 (step SD6). Step SD6 will be explained in detail. The point management unit 204 specifies the record of the user ID 112 included in the first delivery request data from the first management DB 212. Then, the point management unit 204 updates the remaining point information of the specified record to the remaining point information included in the first delivery request data.

Next, the home electric appliance management unit 205 updates the second management DB 213 based on the first delivery request data received in step SD4 (step SD7). Step SD7 will be explained in detail. The home electric appliance management unit 205 generates a record including the user ID 112 and the home electric appliance name information included in the first delivery request data and stores the generated record in the second management DB 213.

### 1-2-3. Operations When Selecting Article on Second Selection Screen

Next, the operations when the user P selects the article BP on the second selection screen SG2 will be explained. The second selection screen SG2 is the selection screen SG that the information processor 1 displays after the first selection screen SG1 is displayed. The second selection screen SG2 is the selection screen SG displayed when the user P selects the article BP for the second time and thereafter after the utilization registration of the subscription service.

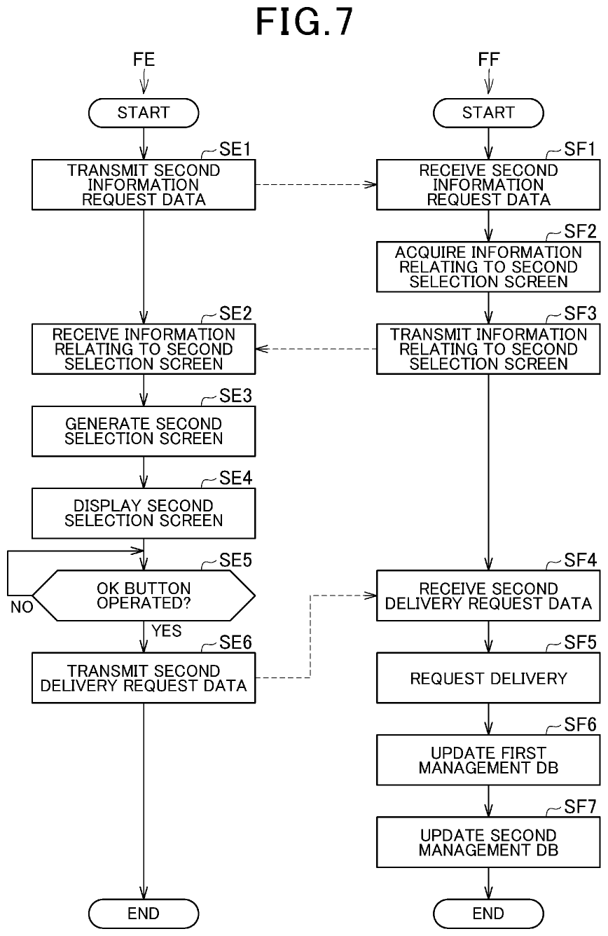

FIG. 7 shows flowcharts illustrating the operations of the information processor 1 and the server device 2.

In FIG. 7, a flowchart FE illustrates the operation of the information processor 1, and a flowchart FF illustrates the operation of the server device 2.

As illustrated in the flowchart FE, the application execution unit 101 transmits second information request data which requests the information relating to the second selection screen SG2 (step SE1). The second information request data includes the user ID 112 stored in the second memory 110.

As illustrated in the flowchart FF, the server communication control unit 201 receives the second information request data from the information processor 1 (step SF1).

The server communication control unit 201 acquires the information relating to the second selection screen SG2 (step SF2). Step SF2 will be explained in detail. In step SF2, the server communication control unit 201 acquires the remaining point information linked with the user ID 112 included in the second information request data received in step SF1 from the first management DB 212, as the information relating to the second selection screen SG2. In addition, in step SF2, the server communication control unit 201 acquires the home electric appliance name information linked with the user ID 112 included in the second information request data received in step SF1 from the second management DB 213, as the information relating to the second selection screen SG2. Further, in step SF2, the server communication control unit 201 acquires all the records from the third management DB 214 and the fourth management DB 215, as the information relating to the second selection screen SG2.

The server communication control unit 201 transmits the information relating to the second selection screen SG2 which is acquired in step SF2 to the information processor 1 (step SF3).

As illustrated in the flowchart FE, the application execution unit 101 receives the information relating to the second selection screen SG2 from the server device 2 (step SE2).

Next, the application execution unit 101 generates the second selection screen SG2 based on the information relating to the second selection screen SG2 which is received in step SE2 (step SE3).

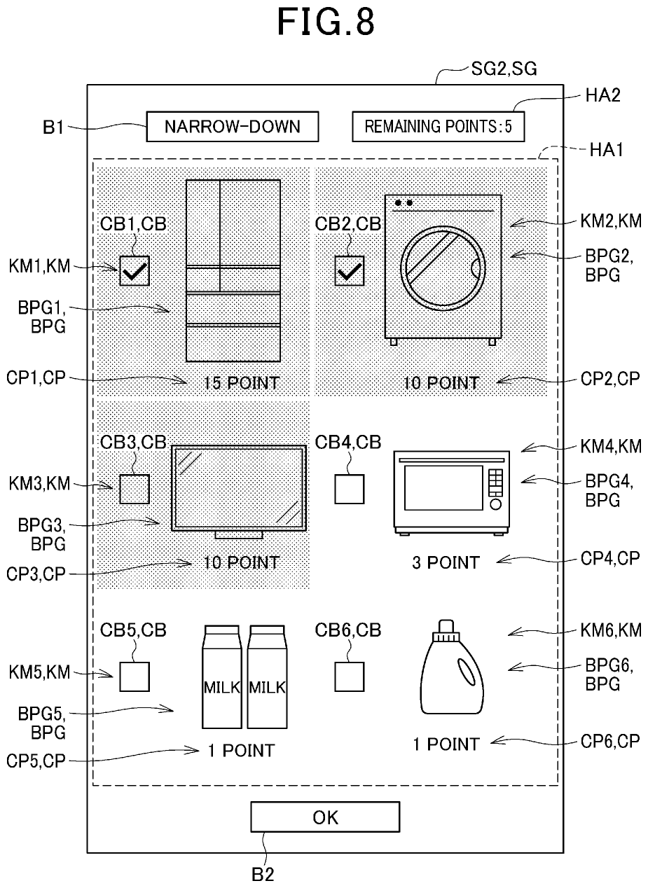

FIG. 8 is a diagram illustrating an example of the second selection screen SG2. In the explanation of the second selection screen SG2, for components which are same as the components of the first selection screen SG1, same signs are attached and detailed explanation is appropriately omitted.

The second selection screen SG2 includes the first display area HA1.

The first display area HA1 displays the home electric appliance HP selected last time in a selected state. The selected state is a state where the checkbox CB is checked and the combination KM is grayed out. The first display area HA1 displays the home electric appliance HP selected last time above the home electric appliances HP and the commodities M not selected last time. Displaying above means displaying to reduce the scroll amount from the time of displaying the second selection screen SG2. By unchecking the checkbox CB of the home electric appliance HP displayed in the selected state, in the first display area HA1, the selected state is canceled.

The first display area HA1 displays the home electric appliance HP not selected last time in a selectable state. The selectable state is a state where the checkbox CB is not checked and the combination KM is not grayed out.

The first display area HA1 displays the commodities M in the selectable state.

In the generation of the second selection screen SG2, the application execution unit 101 generates the combination KM for each of the records stored in the third management DB 214 and the fourth management DB 215 which are received in step SE2. Next, the application execution unit 101 defines that the home electric appliance HP indicated by the home electric appliance name information received in step SE2 as the home electric appliance HP selected last time, and changes the combination KM corresponding to the home electric appliance HP to the selected state. Then, the application execution unit 101 displays the plurality of combinations KM in the first display area HA1, placing the combination KM in the selected state above.

On the second selection screen SG2, similarly to the first selection screen SG1, by checking the checkbox CB, the remaining points NP are subtracted. In addition, on the second selection screen SG2, similarly to the first selection screen SG1, the combination KM corresponding to the article BP of the consumption points CP exceeding the updated remaining points NP is grayed out, and the article BP is displayed in the unselectable manner on the second selection screen SG2.

The second selection screen SG2 includes the narrow-down button B1 and the OK button B2, similarly to the first selection screen SG1.

Returning to the explanation of the flowcharts in FIG. 7, the application execution unit 101 displays the second selection screen SG2 generated in step SE3 on the touch panel 12 (step SE4).

The application execution unit 101 determines whether or not the OK button B2 is operated on the second selection screen SG2 (step SE5).

When it is determined that the OK button B2 is operated (step SE5: YES), the application execution unit 101 transmits second delivery request data to the server device 2 (step SE6). The second delivery request data is data which requests the delivery of the article BP selected on the second selection screen SG2. Note that the article BP selected on the second selection screen SG2 indicates the article BP for which the checkbox CB is checked on the second selection screen SG2. The second delivery request data includes the article name information of the article BP selected on the second selection screen SG2, the remaining point information indicating the remaining points NP when the OK button B2 is operated, and the user ID 112 stored in the second memory 110. Note that the article BP selected on the second selection screen SG2 means the article BP for which the checkbox CB is checked on the second selection screen SG2.

As illustrated in the flowchart FF, the server communication control unit 201 receives the second delivery request data from the information processor 1 (step SF4).

Next, the request unit 206 requests the delivery based on the second delivery request data received in step SF4 (step SF5). Since the article BP is provided by the delivery request, step SF5 corresponds to the step of providing the article BP to the user P.

Step SF5 will be explained in detail. The request unit 206 acquires the address information linked with the user ID 112 included in the second delivery request data from the first management DB 212. Then, when the second delivery request data includes the home electric appliance name information, the request unit 206 acquires the home electric appliance name information linked with the user ID 112 included in the second delivery request data from the second management DB 213. Next, when the kind of the home electric appliance name information included in the second delivery request data and the kind of the home electric appliance name information acquired from the second management DB 213 are different, the request unit 206 requests the delivery for the home electric appliance HP indicated by the home electric appliance name information which is the home electric appliance name information included in the second delivery request data and is different from the one from the second management DB 213. In addition, the request unit 206 requests the collection for the home electric appliance HP indicated by the home electric appliance name information which is the home electric appliance name information acquired from the second management DB 213 and is not included in the second delivery request data. Further, when the second delivery request data includes the commodity name information, the request unit 206 requests the delivery for the commodity M indicated by the commodity name information indicated by the second delivery request data. This makes it possible for the user P to decide provision time. Specifically, for example, the commodity M for the current month can be provided at a timing when the commodity M provided in the previous month is about to run out.

Next, the point management unit 204 updates the first management DB 212 based on the second delivery request data received in step SF4 (step SF6). Step SF6 will be explained in detail. The point management unit 204 specifies the record of the user ID 112 included in the second delivery request data from the first management DB 212. Then, the point management unit 204 updates the remaining point information of the specified record to the remaining point information included in the second delivery request data.

Next, the home electric appliance management unit 205 updates the second management DB 213 based on the second delivery request data received in step SF4 (step SF7). Step SF7 will be explained in detail. The home electric appliance management unit 205 updates the home electric appliance name information linked with the user ID 112 included in the second delivery request data to the home electric appliance name information included in the second delivery request data.

### 1-3. Effects or the Like

As explained above, the service utilization application 111 causes the second processor 100 of the information processor 1 used by the user P of the subscription service including provision of the articles BP associated with the life to function as the application execution unit 101 which displays the selection screen SG where the plurality of articles BP to be provided to the user P are selectable based on the values of the articles BP.

Accordingly, the user P of the subscription service can be provided with the articles BP associated with the life in a desired combination. Thus, convenience of the user of the subscription service can be improved.

To the articles BP, the consumption points CP to be consumed when the articles BP are provided for each article BP are set as the values of the articles BP. To the user P, the points corresponding to the utilization charge of the subscription service are imparted. The application execution unit 101 displays the selection screen SG where the plurality of the articles BP to be provided to the user P are selectable based on the imparted points which are the points imparted to the user P and the consumption points CP.

Accordingly, the user P of the subscription service can be provided with the articles BP associated with the life in a desired combination by utilizing the points. Thus, the convenience of the user of the subscription service can be improved.

On the selection screen SG, the application execution unit 101 displays the article BP to which the consumption points CP equal to or fewer than the remainder of the imparted points are set in the selectable manner, and displays the article BP to which the consumption points CP exceeding the remainder of the imparted points are set in the unselectable manner.

Accordingly, the user P of the subscription service can easily recognize the selectable articles BP. Thus, the convenience of the user P of the subscription service can be improved more.

The articles BP include the home electric appliances HP and the commodities M associated with the home electric appliances HP. On the selection screen SG, when the article BP is selected, the application execution unit 101 subtracts the consumption points CP corresponding to the selected article BP from the remainder of the imparted points, displays the article BP to which the consumption points CP equal to or fewer than the remainder of the imparted points after subtraction are set in the selectable manner, and displays the article BP to which the consumption points CP exceeding the remainder of the imparted points after the subtraction in the unselectable manner.

Accordingly, even when the article BP is selected on the selection screen SG and the remainder of the imparted points is reduced, the user P of the subscription service can easily recognize the selectable articles BP. Thus, the convenience of the user P of the subscription service can be improved more.

The articles BP include the home electric appliances HP and the commodities M associated with the home electric appliances HP. On the selection screen SG, the application execution unit 101 displays the home electric appliance HP selected last time in the selected state, displays the home electric appliance HP not selected last time according to the remainder of the imparted points, and displays the commodity M according to the remainder of the imparted points.

Accordingly, the user P of the subscription service can easily recognize what kind of the home electric appliance HP is the home electric appliance HP selected last time, and the provision of the same home electric appliance HP to the user P can be avoided. Thus, the convenience of the user P of the subscription service can be improved more.

The information processor 1 used by the user P of the subscription service including the provision of the articles BP associated with the life includes the application execution unit 101 which displays the selection screen SG where the plurality of articles BP to be provided to the user P are selectable based on the values of the articles BP.

Accordingly, the effects same as the effects of the service utilization application 111 described above are accomplished.

The service provision system which provides the subscription service including the provision of the articles BP associated with the life includes the information processor 1 used by the user P of the subscription service and the server device 2 which communicates with the information processor 1. The information processor 1 displays the selection screen SG where the plurality of articles BP to be provided to the user P are selectable based on the values of the articles BP. The server device 2 provides the articles BP selected on the selection screen SG to the user P.

Accordingly, the effects same as the effects of the service utilization application 111 described above are accomplished.

A control method of the service provision system 1000 which provides the subscription service including the provision of the articles BP associated with the life includes a step of displaying the selection screen SG where the plurality of articles BP to be provided to the user P are selectable based on the values of the articles BP by the information processor 1 used by the user P of the subscription service, and a step of providing the articles BP selected on the selection screen SG to the user P.

Accordingly, the effects same as the effects of the service utilization application 111 described above are accomplished.

### Other Embodiments

As above, the embodiment 1 has been explained as an example disclosed in the present application. However, the technology in the present disclosure is not limited to this and is also applicable to the embodiments for which changes, replacement, addition and omission or the like are performed. In addition, the individual components explained in the embodiment 1 described above can be combined to attain a new embodiment. Therefore, hereinafter, the other embodiments will be exemplified.

In the embodiment 1 described above, as the articles BP associated with the life, the home electric appliances HP and the commodities M are exemplified. However, the articles BP associated with the life may include furniture in addition to the home electric appliances HP and the commodities M.

In the embodiment 1 described above, the article BP of the consumption points CP exceeding the remaining points NP is made unselectable by graying out the combination KM. In another embodiment, the article BP of the consumption points CP exceeding the remaining points NP may be made unselectable by not displaying the combination KM on the selection screen SG.

In the embodiment 1 described above, the remaining points NP cannot be carried over to the next month. In another embodiment, the remaining points NP may be carried over to the next month. When carry-over to the next month is possible, a time restriction may be provided for the remaining points NP that can be carried over.

In another embodiment, on the selection screen SG, the remainder of the imparted points may be consumed to get insurance of the home electric appliance HP.

In another embodiment, when the selection of the home electric appliance HP selected last time is canceled on the second selection screen SG2, the points corresponding to a collection cost may be subtracted from the remainder of the imparted points.

In another embodiment, on the selection screen SG, the article BP to which the consumption point CP of at least 1 is set may be displayed such that one or more can be selected.

In another embodiment, the user P may be able to additionally purchase the points on the selection screen SG. When the user P additionally purchases the points in the configuration, the additionally purchased points are added to the remaining points NP displayed in the second display area HA2. The first display area HA1 displays the article BP to which the consumption points CP equal to or fewer than the increased remaining points NP are set in the selectable manner when the remaining points NP increased by the additional purchase.

The embodiment 1 described above exemplifies the case where the consumption points CP are set as the values of the articles BP for each article BP. In another embodiment, a rank may be set as the value of the article BP for each article BP and the article BP may be selected based on the rank of the article BP on the selection screen SG. For example, one item from a rank A, one item from a rank B and two items from a rank C may be selected. In addition, in another embodiment, the number of articles may be predetermined based on the selected plan and the determined number of the articles may be selected on the selection screen SG.

In another embodiment, when one home electric appliance HP is selected on the selection screen SG, the commodities M associated with the selected home electric appliance HP may be automatically narrowed down and displayed on the selection screen SG. In addition, in another embodiment, when one home electric appliance HP is selected on the selection screen SG, a recommendation column may be provided in the selection screen SG and the commodities M associated with the selected home electric appliance HP may be displayed in the recommendation column.

In another embodiment, on the selection screen SG, the OK button B2 may not be able to be operated until the remaining points NP become 0.

In another embodiment, the server device 2 may generate the first selection screen SG1 and the server device 2 may transmit the data of the first selection screen SG1 to the information processor 1. In addition, the server device 2 may generate the second selection screen SG2 and the server device 2 may transmit the data of the second selection screen SG2 to the information processor 1.

In another embodiment, the second management DB 213 may manage the data related to the commodity M selected by the user P on the selection screen SG. In this case, one record stored in the second management DB 213 includes the user ID 112, the home electric appliance name information and the commodity name information. On the second selection screen SG2, the first display area HA1 may display the commodity M selected last time in the selected state. Accordingly, the user is restrained from forgetting to select the commodity M and the convenience of the user can be improved.

In another embodiment, on the selection screen SG, only the home electric appliance HP may be selected, or only the commodity M may be selected.

The embodiment 1 described above exemplifies the case where the article BP associated with the life can be utilized for one month when the monthly utilization charge is paid as the subscription service. In another embodiment, a period during which the subscription service can be utilized may be changed. For example, the article BP associated with the life can be utilized for six months when the utilization charge for the six months is paid. In this case, the home electric appliance HP and the commodity M may be selected every month.

In another embodiment, the home electric appliance names and the commodity names may be displayed on the selection screen SG. In addition, the information of the maker of the home electric appliance HP or the retailer of the commodity M may be displayed on the selection screen SG. Further, when the article image BPG is selected, a screen where the article information is mentioned may be superimposed on the selection screen SG and displayed. Note that, when the article image BPG is selected, the screen where the article information is mentioned may be displayed as another screen.

The first processor 200 and the second processor 100 may be configured by a single processor or may be configured by a plurality of processors. The processors may be hardware programmed to realize the corresponding functional units. That is, the processors may be configured by an ASIC (Application Specific Integrated Circuit) or an FPGA (Field Programmable Gate Array), for example.

The configuration of the information processor 1 and the server device 2 illustrated in FIG. 2 is just an example and a specific mounting form is not limited in particular. That is, hardware individually corresponding to each unit does not always need to be mounted, and it is also possible to realize the functions of the individual units by executing the program by one processor. In addition, some of the functions realized by software in the embodiment described above may be turned to the hardware, or some of the functions realized by the hardware may be realized by the software.

Step units of the operations illustrated in FIG. 3, FIG. 4 and FIG. 7 are divided according to main processing contents in order to facilitate understanding of the operations, and the operations are not limited by a division method or names of processing units. Division into more step units may be performed according to the processing contents. In addition, the division may be performed so that one step unit includes more processing. Further, an order of the steps may be appropriately changed without obstructing the gist of the present disclosure.

Note that, since the embodiment described above is to exemplify the technology in the present disclosure, various kinds of changes, replacement, addition and omission or the like can be performed in the scope of claims or in the equal scope.

As above, the storage medium, the information processor, the service provision system and the control method of the service provision system relating to the present invention can be utilized for a use of the subscription service including the provision of the articles associated with the life.

### REFERENCE SIGNS LIST

1 information processor
2 server device
100 second processor (processor)
101 application execution unit (display control unit)
110 second memory
111 service utilization application (program)
201 server communication control unit
202 registration unit
203 imparting unit
204 point management unit
205 home electric appliance management unit
206 request unit
207 notification unit
210 first memory
211 control program
1000 service provision system
BP article
CP consumption points
HP home electric appliance
M commodity
NP remaining points (remainder of imparted points)
SG selection screen
SG1 first selection screen
SG2 second selection screen

What is claimed is:

1. A non-transitory computer-readable storage medium storing a program causing
a processor of an information processor used by a user of a subscription service including provision of articles associated with life
to function as a display control unit configured to display a selection screen where the plurality of articles to be provided are selectable based on values of the articles.

2. The storage medium according to claim 1,
wherein in the program,
consumption points to be consumed when the article is provided for each article are set to the article as the value of the article,
points corresponding to a utilization charge of the subscription service are imparted to the user, and
the display control unit
displays the selection screen where the plurality of articles to be provided to the user are selectable based on imparted points imparted to the user and the consumption points.

3. The storage medium according to claim 2,
wherein in the program,
the display control unit,
on the selection screen,
displays the article to which the consumption points equal to or fewer than a remainder of the imparted points are set in a selectable manner, and
displays the article to which the consumption points exceeding the remainder of the imparted points are set in an unselectable manner.

4. The storage medium according to claim 3,
wherein in the program,
the articles include home electric appliances and commodities associated with the home electric appliances, and
the display control unit,
on the selection screen,
subtracts, when the article is selected, the consumption points corresponding to the selected article from the remainder of the imparted points,
displays the article to which the consumption points equal to or fewer than the remainder of the imparted points after subtraction are set in the selectable manner, and
displays the article to which the consumption points exceeding the remainder of the imparted points after the subtraction are set in the unselectable manner.

5. The storage medium according to claim 3,
wherein in the program,
the articles include home electric appliances and commodities associated with the home electric appliances, and
the display control unit,
on the selection screen,
displays the home electric appliance selected last time in a selected state,
displays the home electric appliance not selected last time according to the remainder of the imparted points, and
displays the commodities according to the remainder of the imparted points.

6. An information processor used by a user of a subscription service including provision of articles associated with life, the information processor comprising
a display control unit configured to display a selection screen where the plurality of articles to be provided are selectable based on values of the articles.

7. A service provision system which provides a subscription service including provision of articles associated with life, the service provision system comprising
the information processor according to claim 6 and a server device configured to communicate with the information processor,
wherein the server device provides the articles selected on the selection screen to the user.

8. A control method of a service provision system which provides a subscription service including provision of articles associated with life, the control method comprising:
a step of displaying a selection screen where the plurality of articles to be provided are selectable based on values of the articles by an information processor used by a user of the subscription service; and
a step of providing the articles selected on the selection screen to the user.
